(19) United States
(12) Patent Application Publication
(10) Pub. No.: US 2024/0324004 A1
(43) Pub. Date: Sep. 26, 2024

(54) INFORMATION TRANSPORT METHOD AND DEVICE

(71) Applicant: VIVO MOBILE COMMUNICATION CO., LTD., Dongguan (CN)

(72) Inventors: Shuyan PENG, Dongguan (CN); Zichao JI, Dongguan (CN)

(73) Assignee: VIVO MOBILE COMMUNICATION CO., LTD., Dongguan (CN)

(21) Appl. No.: 18/677,832

(22) Filed: May 29, 2024

Related U.S. Application Data
(63) Continuation of application No. PCT/CN2022/135187, filed on Nov. 29, 2022.

(30) Foreign Application Priority Data
Nov. 30, 2021 (CN) 202111447735.5

(51) Int. Cl. H04W 74/02; H04W 92/18

(52) U.S. Cl. CPC H04W 74/02; H04W 92/18

(57) ABSTRACT

An information transport method and device are provided. The information transport method includes: transporting by a terminal, information over an SL on a shared band, where the transporting information includes at least one of the following: receiving information, transmitting information, performing channel monitoring, or performing SL channel access.

### CROSS-REFERENCE TO RELATED APPLICATIONS

This application is a continuation of International Application No. PCT/CN2022/135187, filed Nov. 29, 2022, which claims priority to Chinese Patent Application No. 202111447735.5, filed Nov. 30, 2021. The entire contents of each of the above-referenced applications are expressly incorporated herein by reference.

### TECHNICAL FIELD

This application relates to the field of communication technologies and specifically relates to an information transport method and device.

### BACKGROUND

Sidelink (SL) has been supported by the Long Term Evolution (LTE) system since release 12, and is used for direct data transport between terminals without through a network device.

In future communication systems, a shared band, for example, an unlicensed band, may serve as a supplement of a licensed band to help an operator perform service capacity expansion.

If SL transport occurs in a shared band, it is necessary to comply with rule restrictions on the shared band. However, there is no technical solution for SL transport on the shared band in the related art, affecting communication performance.

### SUMMARY

Embodiments of this application provide an information transport method and device.

According to a first aspect, an information transport method is provided, including: transporting, by a terminal, information over an SL on a shared band, where the transporting information includes at least one of the following: receiving information, transmitting information, performing channel monitoring, or performing SL channel access.

According to a second aspect, an information transport apparatus is provided, including: a communication module configured to transport information over an SL on a shared band, where the transporting information includes at least one of the following: receiving information, transmitting information, performing channel monitoring, or performing SL channel access.

According to a third aspect, a terminal is provided. The terminal includes a processor and a memory, where a program or instructions capable of running on the processor are stored in the memory, and when the program or instructions are executed by the processor, the steps of the method according to the first aspect are implemented.

According to a fourth aspect, a terminal is provided, including a processor and a communication interface, where the communication interface is configured to transport information over an SL on a shared band, where the transporting information includes at least one of the following: receiving information, transmitting information, performing channel monitoring, or performing SL channel access.

According to a fifth aspect, an information transport system is provided, including a terminal and a network-side device, where the terminal is configured to execute the steps of the method according to the first aspect.

According to a sixth aspect, a readable storage medium is provided, where the readable storage medium has stored a program or instructions thereon, and when the program or instructions are executed by a processor, the steps of the method according to the first aspect are implemented.

According to a seventh aspect, a chip is provided. The chip includes a processor and a communication interface, where the communication interface is coupled to the processor, and the processor is configured to run a program or instructions to implement the steps of the method according to the first aspect.

According to an eighth aspect, a computer program/program product is provided, where the computer program/program product is stored in a storage medium, and the computer program/program product is executed by at least one processor to implement the steps of the method according to the first aspect.

The information transport method provided in an embodiment of this application allows a terminal to transport information over a sidelink on a shared band, where the transporting information may include at least one of the following: receiving information, transmitting information, performing channel monitoring, or performing SL channel access. The embodiments of this application tackle the problem that communication performance is affected due to the fact that SL transport cannot occur on a shared band, helping to improve communication system performance and enhance resource utilization.

### BRIEF DESCRIPTION OF DRAWINGS

FIG. 1 is a schematic diagram of a wireless communication system according to an embodiment of this application;

FIG. 2 is a schematic flowchart of an information transport method according to an embodiment of this application;

FIG. 3 is a schematic diagram of CP extension according to an embodiment of this application;

FIG. 4 is a schematic diagram showing several cases in an information transport method according to an embodiment of this application;

FIG. 5 is a schematic diagram of GP location according to an embodiment of this application;

FIG. 6 is a schematic diagram of GP location, CP extension, and AGC location according to an embodiment of this application;

FIG. 7 is a schematic diagram of GP location, CP extension, and AGC location according to an embodiment of this application;

FIG. 8 is a schematic diagram of resource monitoring location according to an embodiment of this application;

FIG. 9 is a schematic structural diagram of an information transport apparatus according to an embodiment of this application;

FIG. 10 is a schematic structural diagram of a communication device according to an embodiment of this application; and

FIG. 11 is a schematic structural diagram of a terminal according to an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application fall within the protection scope of this application.

The terms “first”, “second”, and the like in the specification and claims of this application are used to distinguish between similar objects rather than to describe a specific order or sequence. It should be understood that the terms used in this way are interchangeable in appropriate circumstances such that the embodiments of this application can be implemented in other orders than the order illustrated or described herein. In addition, objects distinguished by “first” and “second” are generally of a same type, and the quantities of the objects are not limited. For example, there may be one or more first objects. In addition, in this specification and claims, “and/or” indicates at least one of the connected objects, and the character “/” generally indicates an “or” relationship between the contextually associated objects.

It should be noted that technologies described in the embodiments of this application are not limited to a Long Term Evolution (LTE) or LTE-Advanced (LTE-A) system, and may also be applied to other wireless communication systems, for example, Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application are often used interchangeably, and the technology described herein may be used in the above-mentioned systems and radio technologies as well as other systems and radio technologies. In the following descriptions, a New Radio (NR) system is described for an illustration purpose, and NR terms are used in most of the following descriptions, although these technologies may also be applied to other applications than the NR system application, for example, the 6th Generation (6G) communication system.

FIG. 1 is a block diagram of a wireless communication system to which the embodiments of this application are applicable. The wireless communication system includes a terminal 11 and a network-side device 12. The terminal 11 may be a terminal-side device, such as a mobile phone, a tablet personal computer, a laptop computer or a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), or pedestrian user equipment (PUE), a smart appliance (a home appliance with a wireless communication function, for example, a refrigerator, a television, a washing machine, or furniture), a game console, a personal computer (PC), a teller machine, or a self-service machine. The wearable device includes a smart watch, a smart band, a smart earphone, smart glasses, smart jewelry (a smart bangle, a smart bracelet, a smart ring, a smart necklace, a smart ankle bangle, a smart anklet, or the like), a smart wristband, smart clothing, or the like. It should be noted that the specific type of the terminal 11 is not limited in the embodiments of this application. The network-side device 12 may include an access network device or core network device, where the access network device may also be referred to as a radio access network device, Radio Access Network (RAN), radio access network function, or radio access network unit. The access network device may include base stations, Wireless Local Area Network (WLAN) access points, Wireless Fidelity (WiFi) nodes, or the like. The base station may be referred to as Node B, evolved Node B (eNB), access point, Base Transceiver Station (BTS), radio base station, radio transceiver, Basic Service Set (BSS), Extended Service Set (ESS), home Node B, home evolved Node B, Transmitting Receiving Point (TRP), or other appropriate terms in the field. As long as the same technical effect is achieved, the base station is not limited to any specific technical terminology. It should be noted that in the embodiments of this application, only the base station in the NR system is introduced as an example, and the specific type of the base station is not limited.

The following describes in detail an information transport method provided in the embodiments of this application through some embodiments and application scenarios thereof with reference to the accompanying drawings.

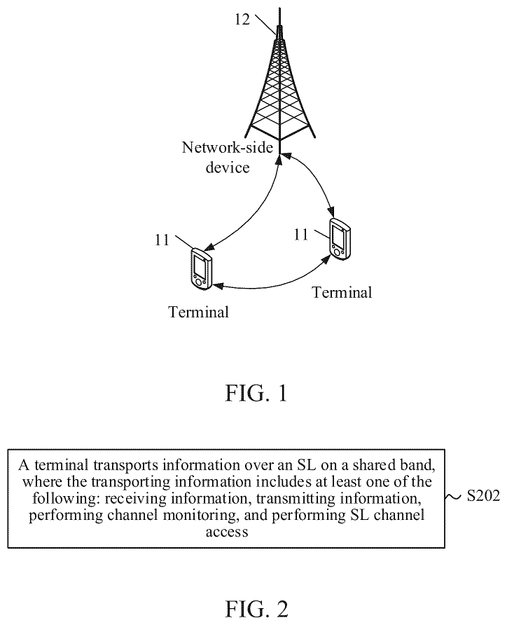

As shown in FIG. 2, an embodiment of this application provides an information transport method 200 on a shared band. The method may be performed by a terminal. In other words, the method may be performed by software or hardware installed on the terminal. The method includes the following step.

S202: A terminal transports information over a sidelink (SL) on a shared band, where the transporting information includes at least one of the following: receiving information, transmitting information, performing channel monitoring, or performing SL channel access.

The shared band described in this embodiment of this application may include an unlicensed band. The terminal may be a transmit terminal (TX UE), a receive terminal (RX UE), a scheduling terminal (scheduling UE), or the like.

The information transported by the terminal over the SL includes, for example, control information, data information, feedback information, synchronization information, reference signal, and discovery information. The information may be transported over an SL channel, where the SL channel includes, for example, a Physical Sidelink Control Channel (PSCCH), a Physical Sidelink Shared Channel (PSSCH), a Physical Sidelink Feedback Channel (PSFCH), a Physical Sidelink Broadcast Channel (PSBCH), and a Physical Sidelink Discovery Channel (PSDCH).

In a first example, in step S202, a terminal receives information over an SL, where this terminal may be a receive terminal. For example, the receive terminal receives information from a transmit terminal on a shared band. In this example, the receive terminal has successfully accessed the shared band, and the receive terminal has acquired resources in the shared band.

In a second example, in step S202, a terminal transmits information over an SL, where this terminal may be a transmit terminal. For example, the transmit terminal transmits information to a receive terminal on a shared band. In this example, the transmit terminal has successfully accessed the shared band, and the transmit terminal has acquired resources in the shared band.

In a third example, in step S202, a terminal performs SL channel access, where a procedure of SL channel access may include: (1) the terminal performs channel monitoring and determines, based on a monitoring result, whether the shared band can be used for transport by the terminal, that is, whether the shared band can be used for SL transport, where the SL transport may be considered as reception or measurement of information; and (2) if a channel is determined to be available, SL channel access is performed on the shared band. For example, the terminal determines whether there is an SL resource in the shared band, and the terminal can perform monitoring based on a resource monitoring method described in a subsequent embodiment of this application. For reception or measurement of the information here, the information may include information on the SL channel or Uplink (UL)/Downlink (DL) information.

In a fourth example, in step S202, a terminal performs channel monitoring (the channel monitoring here may further include signal monitoring). For example, the terminal performs monitoring or measurement on a specified resource to determine whether a channel or the resource is idle.

It can be understood that the four examples described above can be combined to form more embodiments. For example, the third example is combined with the first example, and the third example is combined with the second example.

The information transport method provided in this embodiment of this application allows the terminal to transport information over the sidelink on the shared band, where the transporting information may include at least one of the following: receiving information, transmitting information, performing channel monitoring, or performing SL channel access. This embodiment of this application tackles the problem that communication performance is affected due to the fact that SL transport cannot occur on a shared band, helping to improve communication system performance and enhance resource utilization.

In some embodiments, the terminal transporting information over an SL mentioned in step S202 may include the terminal transporting information over the SL according to indication information, where the indication information includes at least one of the following: scheduled resource; Channel Occupancy Time (COT) information; remaining COT information; shared resource; resource for monitoring; start location of time domain resource; end location of time domain resource; size or length of time domain resource; start location of frequency domain resource; end location of frequency domain resource; size or length of frequency domain resource; Cyclic Prefix (CP) extension information; SL channel access type; Resource Block (RB) set; interlace indication; or remaining interlace indication.

The foregoing indication information may be configured or indicated by a network-side device or a scheduling terminal, or may be predefined.

In the foregoing indication information, the scheduled resource, the COT information, the remaining COT information, the shared resource, and the like may be indicated to the transmit terminal by the network-side device or the scheduling terminal and used for the transmit terminal to perform SL channel access, where step S202 may be executed by the transmit terminal; or the scheduled resource, the COT information, the remaining COT information, the shared resource, and the like may be indicated to the receive terminal by the transmit terminal and used for the receive terminal to perform SL channel access, where step S202 may be executed by the receive terminal.

In the foregoing indication information, the start location of time domain resource, the end location of time domain resource, the size or length of time domain resource, the start location of frequency domain resource, the end location of frequency domain resource, the size or length of frequency domain resource, and the like can all be used for the terminal to transport information in step S202.

In the foregoing indication information, the CP extension information may be used for indicating information of CP extension, where the information of the CP extension includes, for example, location and length of the CP extension. The CP extension is used for the terminal to occupy a channel after successful channel contention. This prevents a resource occupied by the terminal from being preempted by another terminal/user equipment (UE) or system. In addition, this can implement slot-based transmission or mini-slot based transmission.

In the foregoing indication information, the SL channel access type includes, for example, type 1 SL channel access procedure, type 2A SL channel access procedure, type 2B SL channel access procedure, and type 2C SL channel access procedure.

In the foregoing indication information, the RB set, the interlace indication, and the remaining interlace indication may all be frequency domain resource indications.

The indication information mentioned in the foregoing embodiments may be carried in at least one of the following messages or signaling: first-stage Sidelink Control Information (SCI); second-stage SCI; Downlink Control Information (DCI); media access control control element (MAC CE), or Radio Resource Control (RRC) message. The RRC message includes information configured for a base station and PC5-RRC information configured for UE.

The first-stage SCI may be an SCI format 1-A or a newly defined first-stage SCI format. The second-stage SCI may be an SCI format 2-A or SCI format 2-B, or may be a newly defined second-stage SCI format.

In this embodiment, before step S202, the terminal may further receive at least one of the foregoing messages or signaling. The foregoing indication information may be configured or indicated by at least one of the transmit terminal, the scheduling terminal, or the network-side device, or may be predefined.

In this embodiment, for example, the transmit terminal transmits shared COT information to the receive terminal, and the receive terminal performs Clear Channel Assessment (CCA) according to COT indicated by the COT information to determine whether the indicated COT is available. For another example, the scheduling terminal (Scheduling UE) transmits COT information to the transmit terminal, and the transmit terminal performs CCA according to the indicated COT to determine whether the indicated COT is available.

In an example, the indication information includes the CP extension information. Before the transporting, by a terminal, information over an SL, the method further includes the terminal determining information of CP extension according to the CP extension information, where the information of the CP extension may include, a length, a location, and the like of the CP extension, and the length of the CP extension described here may include a duration, a range, or the like of the CP extension.

A range that can be indicated by the CP extension information includes K symbols, and/or a duration T_ext of the CP extension is determined based on at least one of a configured, indicated, or predefined symbol quantity L and a guard time gap Gap, where K is a non-negative integer.

In this embodiment, for example, the range that can be indicated by the CP extension information includes 0-14 symbols. In a case that the range indicated by the CP extension information includes 0 symbols, there is no CP extension. In a case that the range indicated by the CP extension information includes 14 symbols, slot-level boundary alignment can be implemented.

In some embodiments, the duration T_ext of the CP extension is determined according to the following formula: T_ext=L*symbol length-T_sensing-Gap, or T_ext=L*symbol_length-T_sensing, where symbol_length represents a duration of one symbol and is related to an SCS configuration.

T_sensing represents a Listen Before Talk (LBT) duration, may be 16 us or 25 μs, or may be determined based on a channel access procedure or a predefined, configured, or indicated SL channel access mode.

The guard time gap Gap may be 13 μs, 7 μs, or 8 μs and may be determined based on a band of the terminal. For example, if the band of the terminal is FR 2, the guard time gap Gap is 7 μs or 8 μs.

In this embodiment, if the guard time gap is considered, the guard time gap is subtracted when the duration of the CP extension is calculated. This helps a terminal (sensing UE) to have a sufficient gap for switching between receive and transmit (RX->TX), avoiding the communication problem due to untimely switching and helping to improve communication performance.

The terminal mentioned in the foregoing embodiments transports information over the SL according to indication information. In some embodiments, the indication information indicates or allocates M transport resources to the terminal. These M transport resources are not all used for transporting the information, but are allocated to the terminal, so the terminal can further determine a resource for transporting SL information from the M resources. For example, if M resources (the M resources may be consecutive or non-consecutive resources) are allocated to UE, the UE performs a SL channel access procedure on the M resources. If the access is successful, the UE can transport SL information on the M resources. If the access is unsuccessful on the first M1 resources (M1 is greater than or equal to 1, and M1 is less than or equal to M), and the access is successful before the (M1+1)-th resource, the UE can transport SL information on the (M1+1)-th to the M-th resources.

In this embodiment, it is considered that after successful SL channel access, the terminal can transmit/receive information according to some predefined rules/information. Slot-level transmission is mainly considered here. A location for type 2 SL channel access can be determined in a Guard Period (GP)/Automatic Gain Control (AGC), then how resource mapping is performed is determined based on the GP or the AGC.

In some embodiments, in a case that the indication information indicates that the terminal performs M transports, or indicates M transport resources, M being a positive integer, a resource for transport by the terminal over an SL satisfies at least one of the following (1) to (3).

(1) The terminal determines a resource mapping location according to a preset rule or a first parameter.

The preset rule can be used for determining the resource mapping location, and the preset rule may be predefined, or may be configured or indicated by the network-side device or UE.

In some embodiments, information of the resource mapping location includes at least one of the following: a start location, an end location, or a resource length.

In some embodiments, the first parameter includes at least one of the following: source identifier (Source ID); destination identifier (Destination ID); group identifier (Group ID); transport type (for example, unicast, multicast, or broadcast); SubCarrier Spacing (SCS); Quality of Service (QOS); or Channel Access Priority Class (CAPC).

(2) The terminal determines F interlace resources according to an interlace indication in indication information, where F is a positive integer. In this embodiment, it is considered that the interlace resource is used for satisfying the requirement for frequency domain Occupy Channel Bandwidth (OCB).

In some embodiments, the interlace indication satisfies at least one of the following a to d:
a. the interlace indication indicates the F interlace resources in a bitmap manner, for example, the interlace indication is X bits, where X refers to F interlace resources indicated by a bitmap, and X is a positive integer;
b. the interlace indication includes an index of a start interlace resource;
c. the interlace indication includes an index of an end interlace resource; or
d. the interlace indication includes a quantity of the interlace resources.

In an example, the interlace indication includes the index of the start interlace resource and the quantity of the interlace resources. In this example, a Resource Indication Value (RIV) can be used for indication, resulting in a less indication overhead.

In an example, the interlace indication includes the index of the start interlace resource and the index of the end interlace resource.

(3) The terminal performs resource mapping in a configured, indicated, or predefined resource mapping manner.

In some embodiments, the resource mapping manner includes at least one of the following a to c:
a. mapping T time domain resources followed by F frequency domain resources, where T and/or F is a configured, indicated, or predefined positive integer;
b. mapping F frequency domain resources followed by T time domain resources, where T and/or F is a configured, indicated, or predefined positive integer; or
c. mapping time domain resources first or frequency domain resources first, which is determined based on a first condition, where the first condition can be used for determining the mapping manner, and the first condition may be predefined, may be configured or indicated by the network-side device, or may be configured or indicated by UE.

In an example, the resource mapping location includes the start location, and the start location is determined according to the preset rule; and the transporting, by a terminal, information over an SL includes at least one of the following:

(1) the terminal starts mapping, in the 1st transport resource (for example, slot), SL information at the 2nd symbol of the transport resource, and/or information of the 1st symbol is a repetition of information of the 2nd symbol or information of the last half symbol of the 1st symbol is a partial repetition of the information of the 2nd symbol; or

(2) the terminal starts mapping, in the 2nd to M-th transport resources, SL information at the 1st symbol of the transport resource. In this example, there is no AGC symbol in the 2nd to M-th transport resources.

The SL information mentioned in the embodiments of this application includes, for example, PSCCH, PSSCH, and Reference Signal (RS), and may be information transported in step S202.

In an example, the resource mapping location includes the start location, and the start location is determined according to the first parameter; and the transporting, by a terminal, information over an SL includes at least one of the following:
(1) in a case that destination identifiers for multiple transports are the same, only in the first transport, information of the 1st symbol is a repetition of information of the 2nd symbol or information of the last half symbol of the 1st symbol is a partial repetition of information of the 2nd symbol, where in this example, there is no AGC symbol in the 2nd to M-th transport resources;
(2) in a case that destination identifiers for multiple transports are different, in the 1st resource unit in transport resources corresponding to different destination identifiers, information of the 1st symbol is a repetition of the 2nd symbol or information of the last half symbol of the 1st symbol is a partial repetition of information of the 2nd symbol; or
(3) in a case that an SCS is a first SCS, information of the last half symbol of the 1st symbol is a partial repetition of information of the 2nd symbol, where in this example, for example, SCS=30 kHz, so that AGC is half a symbol and is an LBT+GP reservation resource.

In an example, the resource mapping location includes the end location, and the end location is determined according to the preset rule; and the transporting, by a terminal, information over an SL includes at least one of the following:
(1) the terminal maps, in first M-1 transport resources, SL information to the last symbol or the N₁-th symbol of the transport resources, where in this example, there is no GP (Guard Period) symbol in the first M-1 transport resources; or
(2) the terminal maps, in the M-th transport resource or the last transport resource, SL information to the penultimate symbol or the (N₁-1)-th symbol of the transport resource, where N₁ is a positive integer, and N₁ may be 14, where in this example, there is a GP symbol in the M-th transport resource.

In an example, the resource mapping location includes the end location, and the end location is determined according to the first parameter; and the transporting, by a terminal, information over an SL satisfies the following: in a case that source identifiers for multiple transports are the same, a GP is present in the last symbol of the M-th transport resource or in the last transport. In this example, there is no GP symbol in the first (M-1)-th transport resource, and the last symbol of the last transport is a GP symbol.

In some embodiments, the performing, by a terminal, SL channel access over an SL, mentioned in the foregoing embodiments, includes: performing, by the terminal, channel monitoring, where a resource location at which the terminal performs channel monitoring satisfies at least one of the following:
(1) the terminal starts monitoring at a start location of a time unit immediately before an indicated resource;
(2) the terminal starts monitoring at a location shifted backward by a time units from a start location of a time unit immediately before an indicated resource;
(3) the terminal starts monitoring at a location shifted forward by b time units from an end location of a time unit immediately before an indicated resource; or
(4) the terminal starts monitoring at a location shifted forward by c time units from a start location of an indicated resource; where a, b, and c are positive integers.

It should be noted that the time unit mentioned in the embodiments of this application may be slot, symbol, frame, subframe, millisecond, second, and the like.

In this embodiment, for example, the terminal determines a location for resource monitoring according to resource information (for example, remaining COT information, COT information, RB set, and remaining interlace indication) indicated by the indication information. In this embodiment, it is considered that the terminal can determine a location for type 2 resource monitoring in a shared COT, that a transport gap in the COT is less than 16 μs and the COT is not lost, and that the gap satisfies the switching requirement for 13 μs or 7 μs.

To describe in detail the information transport method provided in the embodiments of this application, the following provides descriptions with reference to several specific embodiments.

### Embodiment 1

In this embodiment, an indication of COT or LBT (Listen Before Talk) is mainly described.

In this embodiment, a transmit terminal or a scheduling terminal transmits SCI (for example, the 1st SCI/2nd SCI), where the SCI includes indication information, and the indication information indicates remaining COT information, RB set, remaining interlace indication, and the like.

The terminal performs SL channel access on an indicated time-frequency resource according to remaining COT information, RB set, remaining interlace indication, and the like indicated in SCI detected by sensing. In this embodiment, the terminal can perform channel sensing in Cat 2 25 μs/Cat 2 16 μs/Cat 4/Cat 1 LBT (corresponding to monitoring manners of different types of channel access procedures).

In some embodiments, the transmit terminal or the scheduling terminal transmits the foregoing indication information using the 1st SCI, where the remaining COT information and the RB set are carried in the remaining COT information. In some embodiments, the indication information is jointly encoded with a reservation resource indication; or the indication information is an independent indication.

### Embodiment 2

In this embodiment, an indication of CP extension information is mainly described.

In this embodiment, a transmit terminal indicates the CP extension information in SCI, and a receive terminal determines a length of CP extension and a start location of a slot or data transport according to the CP extension information.

A range of the CP extension is 0-M, where M is a predefined or configured parameter. In some embodiments, M is a configuration associated with an SCS.

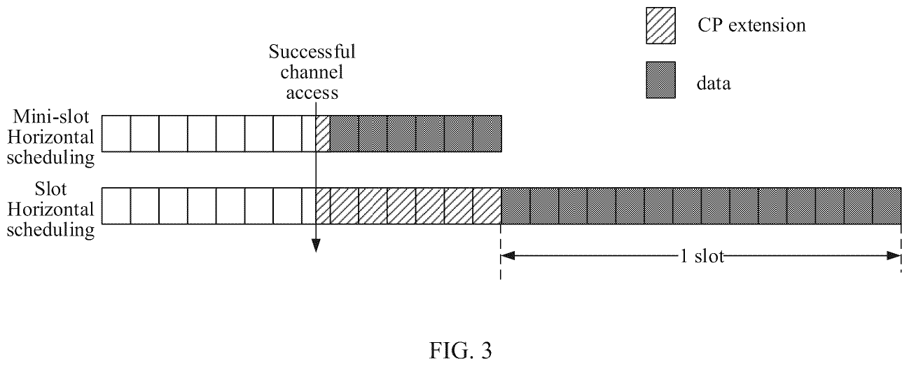

A range of values of the CP extension is shown in FIG. 3. and an arrow in a vertical direction in FIG. 3 indicates a location at which channel access is successful. In the second line of FIG. 3, the CP extension is half a symbol; and in the third line of FIG. 3, the CP extension is 6.5 symbols. The CP extension is intended to implement slot boundary alignment.

In this embodiment, the terminal employs the CP extension in the first channel access and does not employ the CP extension in subsequent transports, which can implement the slot boundary alignment.

### Embodiment 3

This embodiment may be described in the following multiple cases.

### Case 1:

A transmit terminal continuously performs M transports, and source UE and destination UE for the M transports are the same.

In the 1st transport, mapping of a PSSCH starts at the 2nd symbol of a start location of an SL resource, and the PSSCH is mapped to the last symbol of the SL resource or the last symbol of the slot. The 1st symbol is a repetition of the 2nd symbol. That is, AGC is present in the 1st slot.

In the 2nd to (M-1)-th transports, mapping of the PSSCH starts at the 1st symbol of the slot (no AGC is present), and the PSSCH is mapped to the last symbol of the slot, that is, neither AGC nor GP is present in the 2nd to (M-1)-th slots.

In the M-th transport, mapping of the PSSCH starts at the 1st symbol of the slot, and the PSSCH is mapped to the 13th symbol of the slot, where the last symbol of the slot is a guard period symbol, and a GP is present in the last slot.

This embodiment is applicable to continuous transports between a pair of terminals.

### Case 2:

A transmit terminal continuously performs M transports, and source UE and destination UE for the M transports are different.

A structure and a resource mapping manner may be the same as that of case 1.

It is assumed that the transmit terminal does not perform power adjustment in the 2nd slot, receptions of other terminals in a system are not affected. However, if a receive terminal does not perform AGC, it may cause that the receive terminal may be unable to demodulate due to excessively high or excessively low power.

It is assumed that the transmit terminal performs power adjustment in the 2nd slot, if there is Frequency Division Multiplexing (FDM) between other terminals and the UE, and other terminals have no AGC adjustment time, it may lead to the near-far effect, and signals cannot be correctly received. Without AGC adjustment time, the receive terminal may be unable to demodulate.

In this embodiment, no AGC adjustment is performed in the 2nd slot, which may reduce PRR of an SL system.

### Case 2-1:

A transmit terminal continuously performs M transports, and source UE and destination UE for the M transports are different.

In the 1st transport, mapping of a PSSCH starts at the 2nd symbol of a start location of an SL resource, and the PSSCH is mapped to the last symbol of the SL resource or the last symbol of the slot. The 1st symbol is a repetition of the 2nd symbol, that is, AGC is present in the 1st slot.

In the 2nd to (M-1)-th transports, in a slot with variable destination UE or a slot with variable power, mapping of the PSSCH starts at the 2nd symbol of the slot (AGC for 1 symbol is present), and the PSSCH is mapped to the last symbol of the slot, where in the 2nd to (M-1)-th slots, AGC is present and no GP is present.

In the M-th transport, mapping of the PSSCH starts at the 1st symbol of the slot, and the PSSCH is mapped to the 13th symbol of the slot, where the last symbol of the slot is a guard period symbol, that is, a GP is present in the last slot.

This embodiment can enhance PRR of an SL system.

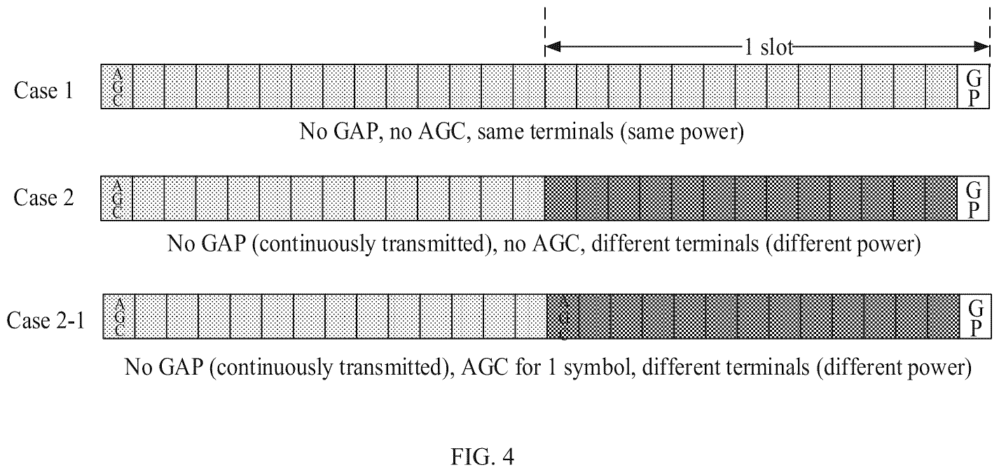

For the foregoing case 1, case 2, and case 2-1, reference may be made to FIG. 4.

### Case 3:

A transmit terminal has detected that N resources are occupied, where the first M transports are used for transmitting information, remaining (N-M) resources are shared with another terminal, for example, shared with a receive terminal for the receive terminal to transmit information.

In the first M transports, the transmit terminal transports information according to the foregoing case 1 or case 2.

In the first M-1 slots, the receive terminal receives information according to the foregoing case 1 or case 2. In the last symbol of the (M-1)-th transport, the receive terminal performs a type 2A SL channel access procedure according to predefined, configured, or indicated information. If the SL channel access is successful, mapping of a PSSCH of the receive terminal starts at the 2nd symbol of the M-th slot, where the 1st symbol is a repetition of the 2nd symbol. Channel access time is located in the last GP and shares one symbol with the GP.

In some embodiments, if the resource is shared with another terminal for use, the another terminal is a receive terminal not corresponding to the 1st slot.

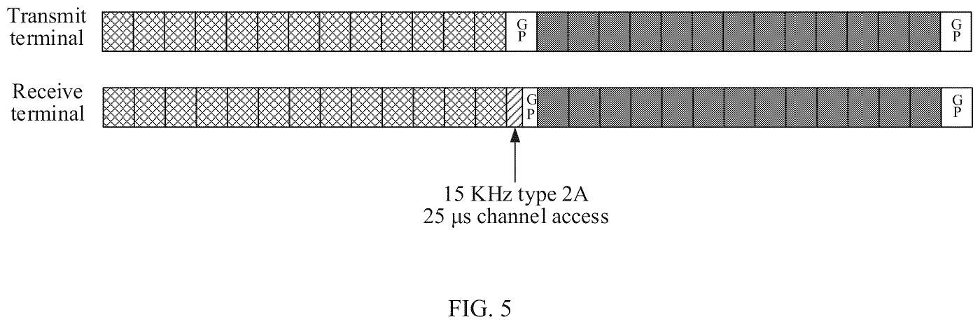

As shown in FIG. 5, at 15 kHz, one symbol duration is 72 μs. It is enough for the GP and the type 2A channel access to share one symbol. At 30 KHz, 25 μs is needed for the type 2A channel access, and remaining time in this symbol is 11 μs. For FR 1, the receive terminal cannot switch from a receive state to a transmit state; and for FR 2, the receive terminal can switch from the receive state to the transmit state.

### Embodiment 4

This embodiment may be described in the following two cases.

Case A: At 15 kHz or 30 kHz, AGC for 1 symbol.

In this embodiment, AGC for 1 symbol is predefined, configured, or indicated; or the 1 st symbol of a slot is a repetition of the 2nd symbol.

A terminal performs a type 2A channel access procedure in one symbol immediately before an indicated slot.

In some embodiments, the terminal transports CP extension according to predefined, configured, or indicated information. The CP extension is intended to ensure that a channel is preempted after CCA access is successful.

In some embodiments, the terminal does not transport information after LBT. The presence of a gap longer than 25 μs may lead to channel loss, requiring to monitor again.

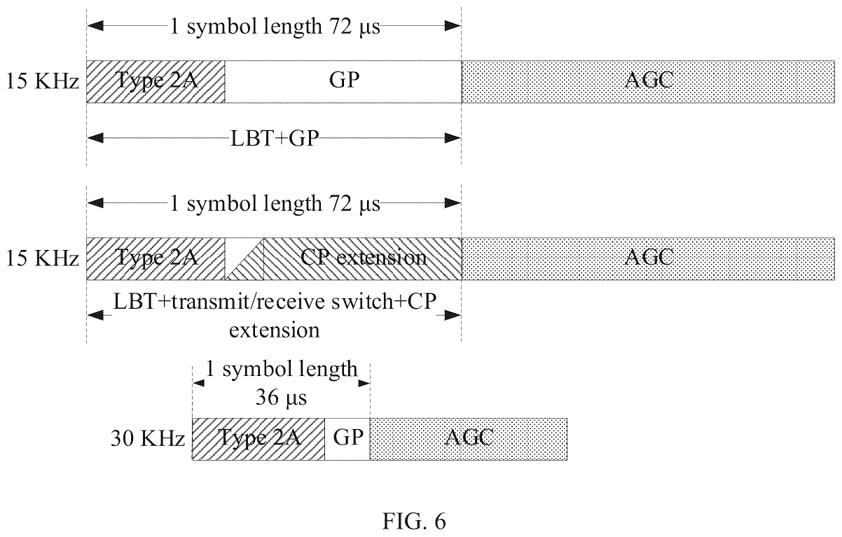

As shown in FIG. 6, for 15 kHz, the remaining time other than LBT in 1 symbol is 47 μs, which can satisfy the requirement for switching between TX (Transmit) and RX (Receive). For 30 kHz, the remaining time other than LBT in 1 symbol is 11 μs, which cannot satisfy the requirement for switching between TX and RX under FR 1. In one case, it is deemed that in LBT of 25 μs, 4 μs idle in the last sensing slot (the sensing slot defined in LBT is 9 μs) is located at a location of the first 4 μs of the sensing slot, so the last us of LBT can be used for switching between TX and RX, which can satisfy the requirement for a switching time of 13 μs.

Case B: At 30 kHz, AGC for half a symbol.

In this embodiment, AGC for half a symbol is predefined, configured, or indicated; or the last half symbol of the 1st symbol of a slot is a repetition of the 2nd symbol.

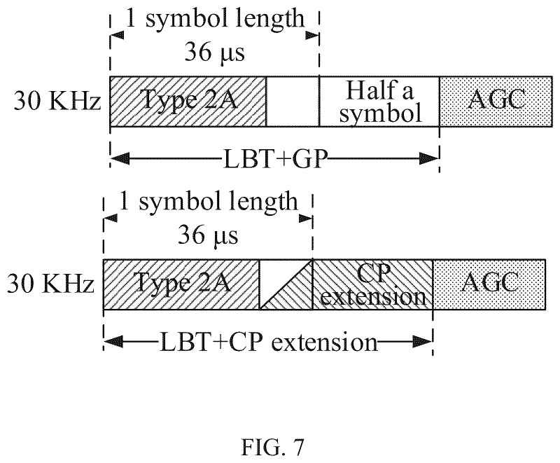

As shown in FIG. 7, a terminal performs a type 2A channel access procedure in one symbol immediately before an indicated slot.

In some embodiments, the terminal transports CP extension according to predefined, configured, or indicated information. The CP extension is intended to ensure that a channel is preempted after CCA access is successful.

In some embodiments, the terminal does not transport information after LBT. The presence of a gap of longer than 25 μs may lose the channel, so it needs to monitor again.

If the type 2A channel access is successful, mapping of a PSSCH starts at the 2nd symbol of an indicated resource, where the last half symbol of the 1st symbol of the indicated resource is a repetition of partial information of the 2nd symbol of the indicated resource.

### Embodiment 5

In this embodiment, selection of a type 2 sensing location is mainly described.

In this embodiment, a terminal performs a type 2A channel access procedure (which may include type 2A/type 2B/type 2C channel access) in the last symbol of an indicated resource.

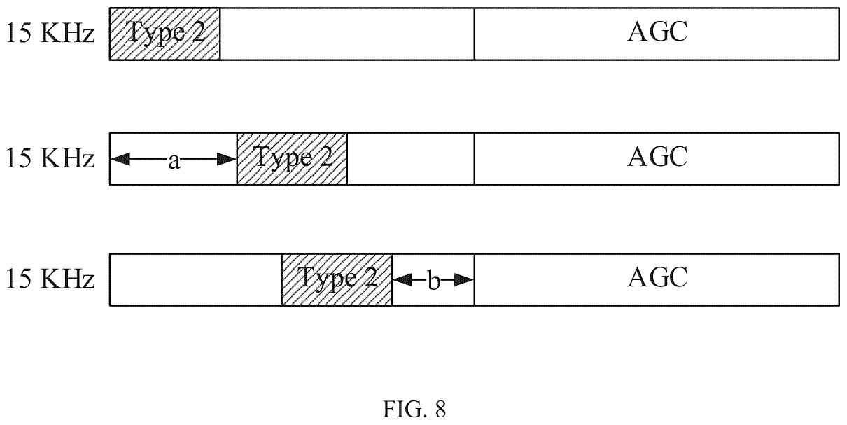

In some embodiments, as shown in the first line of FIG. 8, the terminal performs channel access at a start location of the last symbol.

In some embodiments, as shown in the second line of FIG. 8, the terminal performs channel access at a location shifted backward by a time units from a start location of the last symbol.

In some embodiments, as shown in the third line of FIG. 8, the terminal performs channel access in b time units immediately before an end location of the last symbol or a start location of an indicated resource.

The information transport method provided in this embodiment of this application can be executed by an information transport apparatus. In the embodiments of this application, the information transport method being executed by the information transport apparatus is used as an example to describe an information transport apparatus provided in an embodiment of this application.

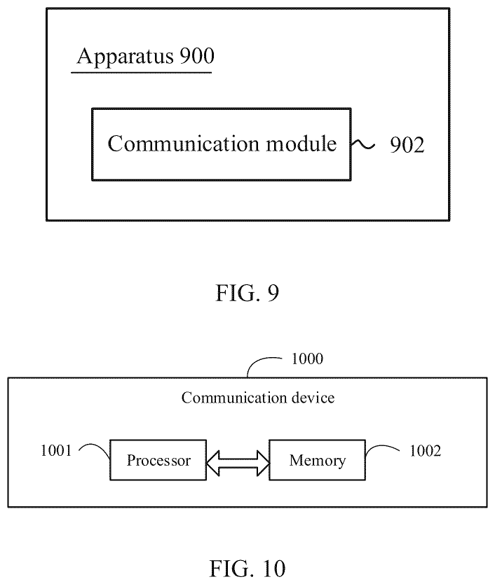

FIG. 9 is a schematic structural diagram of an information transport apparatus according to an embodiment of this application. The apparatus may correspond to a terminal in another embodiment. As shown in FIG. 9, the apparatus 900 includes the following module:

a communication module 902 which may be configured to transport information over an SL on a shared band, where the transporting information includes at least one of the following: receiving information, transmitting information, performing channel monitoring, or performing SL channel access.

In some embodiments, the apparatus 900 further includes a processing module such as a processor.

In the information transport apparatus in this embodiment of this application, the communication module can transport information over a sidelink, where the transporting information may include at least one of the following: receiving information, transmitting information, performing channel monitoring, or performing SL channel access. This embodiment of this application tackles the problem that the communication performance is affected due to the fact that the SL cannot be transported on a shared band, helping to improve the performance of a communication system and enhance resource utilization.

In an embodiment, the communication module 902 is configured to transport information over an SL according to indication information, where the indication information includes at least one of the following: scheduled resource; COT information; remaining COT information; shared resource; resource for monitoring; start location of time domain resource; end location of time domain resource; size or length of time domain resource; start location of frequency domain resource; end location of frequency domain resource; size or length of frequency domain resource; CP extension information; SL channel access type; RB set; interlace indication; or remaining interlace indication.

In an embodiment, the indication information is carried in at least one of the following: first-stage SCI; second-stage SCI; DCI; MAC CE; or RRC message.

In an embodiment, the indication information includes the CP extension information. The apparatus further includes a processing module configured to determine information of CP extension according to the CP extension information, where a range indicated by the CP extension information includes K symbols, and/or a duration T_ext of the CP extension is determined based on at least one of a configured, indicated, or predefined symbol quantity L and a guard time gap Gap, where K is a non-negative integer.

In an embodiment, the duration T_ext of the CP extension is determined according to the following formula: T_ext=L*symbol_length-T_sensing-Gap or T_ext=L*symbol_length-T_sensing, where symbol_length represents a duration of one symbol, and T_sensing represents a duration of listen before talk LBT.

In an embodiment, in a case that the indication information indicates that the apparatus performs M transports, or indicates M transport resources, M being a positive integer, a resource transported by the communication module 902 over an SL satisfies at least one of the following: a resource mapping location is determined according to a preset rule or a first parameter; F interlace resources are determined according to an interlace indication in indication information, where F is a positive integer; or resource mapping is performed in a configured, indicated, or predefined resource mapping manner.

In I an embodiment, information of the resource mapping location includes at least one of the following: a start location, an end location, or a resource length. The first parameter includes at least one of the following: source address identifier; destination address identifier; group identifier; transmission type; SCS; QoS; or CAPC.

In an embodiment, the resource mapping location includes the start location, and the start location is determined according to the preset rule. The communication module 902 is configured to perform at least one of the following: (1) starting mapping, in the 1st transport resource, SL information at the 2nd symbol of the transport resource, and/or information of the 1st symbol is a repetition of information of the 2nd symbol or information of the last half symbol of the 1st symbol is a partial repetition of the information of the 2nd symbol; or (2) starting mapping, in the 2nd to M-th transport resources, SL information at the 1st symbol of the transport resource.

In an embodiment, the resource mapping location includes the start location, and the start location is determined according to the first parameter. The communication module 902 is used for at least one of the following cases: (1) in a case that destination identifiers for multiple transports are the same, only in the first transport, information of the 1st symbol is a repetition of information of the 2nd symbol or information of the last half symbol of the 1st symbol is a partial repetition of information of the 2nd symbol; (2) in a case that destination identifiers for multiple transports are different, in the 1st resource unit in transport resources corresponding to different destination identifiers, information of the 1st symbol is a repetition of the 2nd symbol or information of the last half symbol of the 1st symbol is a partial repetition of information of the 2nd symbol; or (3) in a case that an SCS is a first SCS, information of the last half symbol of the Ist symbol is a partial repetition of information of the 2nd symbol.

In an embodiment, the resource mapping location includes the end location, and the end location is determined according to the preset rule. The communication module 902 is configured to perform at least one of the following: (1) mapping, in first M-1 transport resources, SL information to the last symbol or the N₁-th symbol of the transport resource; or (2) mapping, in the M-th transport resource or the last transport resource, SL information to the penultimate symbol or the (N₁-1)-th symbol of the transport resource, where N₁ is a positive integer.

In an embodiment, the resource mapping location includes the end location, and the end location is determined according to the first parameter. In a case that source identifiers for multiple transports are the same, a guard period GP is present in the last symbol of the M-th transport resource or in the last transport.

In an embodiment, the interlace indication satisfies at least one of the following: (1) the interlace indication indicates the F interlace resources in a bitmap manner; (2) the interlace indication includes an index of a start interlace resource; (3) the interlace indication includes an index of an end interlace resource; or (4) the interlace indication includes a quantity of the interlace resources.

In an embodiment, the resource mapping manner includes at least one of the following: (1) mapping T time domain resources followed by F frequency domain resources; (2) mapping F frequency domain resources followed by T time domain resources; or (3) mapping time domain resources first or frequency domain resources first, which is determined based on a first condition; where T and/or F is a configured, indicated, or predefined positive integer.

In an embodiment, the communication module 902 is configured to perform channel monitoring, where a resource location at which the communication module performs channel monitoring satisfies at least one of the following: (1) monitoring starts at a start location of a time unit immediately before an indicated resource; (2) monitoring starts at a location shifted backward by a time units from a start location of a time unit immediately before an indicated resource; (3) monitoring starts at a location shifted forward by b time units from an end location of a time unit immediately before an indicated resource; and (4) monitoring starts at a location shifted forward by c time units from a start location of an indicated resource; where a, b, and c are positive integers.

For the apparatus 900 according to this embodiment of this application, reference may be made to the processes of the method 200 in the corresponding embodiment of this application, and the units or modules of the apparatus 900 and other operations and/or functions described above are respectively intended to implement the corresponding processes in the method 200, with the same or equivalent technical effects achieved. For brevity, details are not described herein again.

The information transport apparatus in this embodiment of this application may be an electronic device, for example an electronic device having an operating system, or may be a component of an electronic device, for example, an integrated circuit or a chip. The electronic device may be a terminal or a device other than terminals. For example, the terminal may include but is not limited to the types of the terminal 11 listed above, and the other devices may be a server, a network attached storage (NAS), or the like, which are not specifically limited in the embodiments of this application.

The information transport apparatus provided in this embodiment of this application can implement the processes implemented in the method embodiments of FIG. 2 to FIG. 7, with the same technical effects achieved. To avoid repetition, details are not described herein again.

As shown in FIG. 10, an embodiment of this application further provides a communication device 1000 including a processor 1001 and a memory 1002. A program or instructions capable of running on the processor 1001 can be stored in the memory 1002. For example, in a case that the communication device 1000 is a terminal, when the program or instructions are executed by the processor 1001, the steps of the foregoing information transport method are implemented, with the same technical effects achieved. To avoid repetition, details are not described herein again.

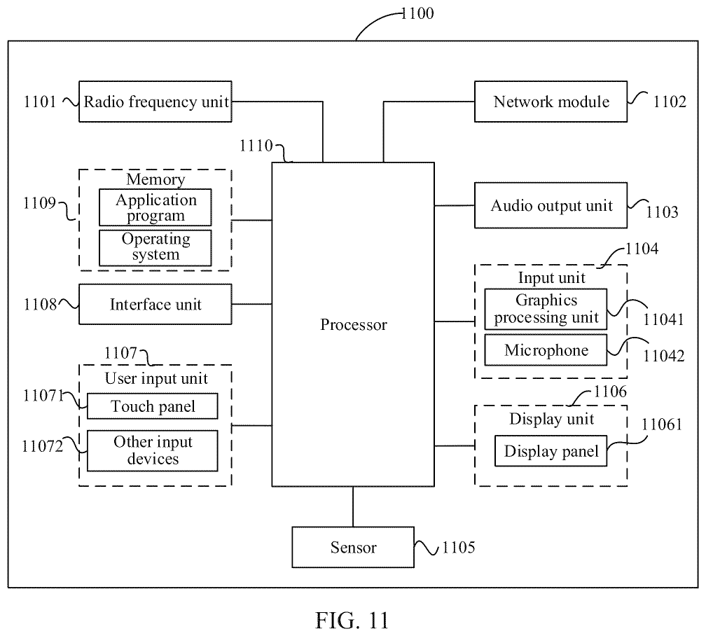

An embodiment of this application further provides a terminal including a processor and a communication interface, where the communication interface is configured to transport information over a sidelink on a shared band, where the transporting information may include at least one of the following: receiving information, transmitting information, performing channel monitoring, and performing SL channel access. This terminal embodiment corresponds to the foregoing method embodiment on the terminal side. All processes and implementations in the foregoing method embodiment can be applicable to this terminal embodiment, with the same technical effects achieved. FIG. 11 is a schematic diagram of a hardware structure of a terminal implementing the embodiments of this application.

The terminal 1100 includes but is not limited to at least some of these components: a radio frequency unit 1101, a network module 1102, an audio output unit 1103, an input unit 1104, a sensor 1105, a display unit 1106, a user input unit 1107, an interface unit 1108, a memory 1109, a processor 1110, and the like.

It can be understood by those skilled in the art that the terminal 1100 may further include a power supply (for example, battery) supplying power to the components. The power supply may be logically connected to the processor 1110 via a power management system, so that functions such as charge management, discharge management, and power consumption management are implemented via the power management system. The structure of the terminal shown in FIG. 11 does not constitute any limitation on the terminal, and the terminal may include more or fewer components than shown in the figure, or combine some of the components, or have different arrangements of the components. Details are not described herein.

It should be understood that in this embodiment of this application, the input unit 1104 may include a graphics processing unit (GPU) 11041 and a microphone 11042. The graphics processing unit 11041 processes image data of still pictures or videos that are obtained by an image capture apparatus (for example, camera) in an image or video capture mode. The display unit 1106 may include a display panel 11061. The display panel 11061 may be configured in a form of a liquid crystal display, an organic light-emitting diode display, or the like. The user input unit 1107 includes at least one of a touch panel 11071 and other input devices 11072. The touch panel 11071 is also referred to as a touchscreen. The touch panel 11071 may include two parts: a touch detection apparatus and a touch controller. The other input devices 11072 may include but are not limited to a physical keyboard, a function button (for example, volume control button or on/off button), a trackball, a mouse, and a joystick. Details are not described herein.

In this embodiment of this application, the radio frequency unit 1101 receives downlink data from a network-side device and transfers the data to the processor 1110 for processing; and the radio frequency unit 1101 can additionally send uplink data to the network-side device. Generally, the radio frequency unit 1101 includes but is not limited to an antenna, an amplifier, a transceiver, a coupler, a low noise amplifier, a duplexer, and the like.

The memory 1109 may be configured to store software programs or instructions and various data. The memory 1109 may include a first storage area for storing programs or instructions and a second storage area for storing data. The first storage area may store an operating system, an application program or instructions required by at least one function (for example, a sound playback function or an image playback function), and the like. Additionally, the memory 1109 may include a volatile memory or a non-volatile memory, or the memory 1109 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 1109 in this embodiment of this application includes but is not be limited to these and any other applicable types of memories.

The processor 1110 may include one or more processing units. In some embodiments, the processor 1110 may integrate an application processor and a modem processor. The application processor primarily processes operations involving an operating system, user interface, application program, or the like. The modem processor primarily processes wireless communication signals, for example, being a baseband processor. It can be understood that the modem processor may be not integrated in the processor 1110.

The radio frequency unit 1101 may be configured to transport information over a sidelink on a shared band, where the transporting information may include at least one of the following: receiving information, transmitting information, performing channel monitoring, and performing SL channel access.

In this embodiment of this application, the terminal may be configured to transport information over the sidelink, where the transporting information may include at least one of the following: receiving information, transmitting information, performing channel monitoring, and performing SL channel access. This embodiment of this application tackles the problem that the communication performance is affected due to the fact that the SL cannot be transported on a shared band, helping to improve the performance of a communication system and enhance resource utilization.

The terminal 1100 provided in this embodiment of this application can further implement the processes of the information transport method embodiments, with the same technical effects achieved. To avoid repetition, details are not described herein again.

An embodiment of this application further provides a readable storage medium, where the readable storage medium has stored a program or instructions thereon, and when the program or instructions are executed by a processor, the processes of the foregoing information transport method embodiments are implemented, with the same technical effects achieved. To avoid repetition, details are not described herein again.

The processor is a processor in the terminal described in the foregoing embodiment. The readable storage medium includes a computer-readable storage medium such as a computer read-only memory ROM, a random access memory RAM, a magnetic disk, or an optical disc.

Another embodiment of this application provides a chip. The chip includes a processor and a communication interface, where the communication interface is coupled to the processor, and the processor is configured to run a program or instructions to implement the processes of the foregoing information transport method embodiments, with the same technical effects achieved. To avoid repetition, details are not described herein again.

It should be understood that the chip mentioned in this embodiment of this application may also be referred to as a system-level chip, a system chip, a chip system, a system-on-chip, or the like.

An embodiment of this application further provides a computer program or program product, where the computer program or program product is stored in a readable storage medium, and the computer program product is executed by at least one processor to implement the processes of the foregoing information transport method embodiments, with the same technical effects achieved. To avoid repetition, details are not described herein again.

An embodiment of this application further provides an information transport system including a terminal and a network-side device. The terminal is configured to execute the steps of the foregoing information transport method.

It should be noted that in this specification, the terms “include”, “comprise”, or any of their variants are intended to cover a non-exclusive inclusion, such that a process, method, article, or apparatus that includes a series of elements includes not only those elements but also other elements that are not expressly listed, or further includes elements inherent to such process, method, article, or apparatus. Without more restrictions, an element preceded by the statement “includes a . . . ” does not preclude the presence of other identical elements in the process, method, article, or apparatus that includes the element. In addition, it should be noted that the scope of the method and apparatus in the implementations of this application is not limited to functions being performed in the order shown or discussed, but may further include functions being performed at substantially the same time or in a reverse order, depending on the functions involved. For example, the described method may be performed in an order different from the order described, and steps may be added, omitted, or combined. In addition, features described with reference to some examples may be combined in other examples.

Based on the above description of the embodiments, persons skilled in the art can clearly understand that the method in the foregoing embodiments can be implemented through software on a necessary hardware platform or through hardware only. Based on such an understanding, the technical solutions of this application essentially or the part contributing to the prior art may be implemented in a form of a computer software product. The software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific implementations. These specific implementations are merely for illustration rather than limitation. Inspired by this application, persons of ordinary skill in the art may develop many other forms without departing from the essence of this application and the protection scope of the claims, and all such forms shall fall within the protection scope of this application.

What is claimed is:

1. An information transport method, comprising:
transporting, by a terminal, information over a sidelink (SL) on a shared band,
wherein the transporting information comprises at least one of the following: receiving information, transmitting information, performing channel monitoring, or performing SL channel access.

2. The information transport method according to claim 1, wherein the transporting, by a terminal, information over an SL comprises: transporting, by the terminal, information over the SL according to indication information, wherein the indication information comprises at least one of the following:
scheduled resource; channel occupancy time (COT) information; remaining COT information; shared resource; resource for monitoring; start location of time domain resource; end location of time domain resource; size or length of time domain resource; start location of frequency domain resource; end location of frequency domain resource; size or length of frequency domain resource; cyclic prefix (CP) extension information; SL channel access type; resource block (RB) set; interlace indication; or remaining interlace indication.

3. The information transport method according to claim 2, wherein the indication information is carried in at least one of the following:
first-stage sidelink control information (SCI); second-stage SCI; downlink control information (DCI); media access control control element (MAC CE); or radio resource control (RRC) message.

4. The information transport method according to claim 2, wherein the indication information comprises the CP extension information; and before the transporting, by a terminal, information over an SL, the information transport method further comprises:
determining, by the terminal, information of CP extension according to the CP extension information,
wherein a range indicated by the CP extension information comprises K symbols, or a duration T_ext of the CP extension is determined based on at least one of a configured, indicated, or predefined symbol quantity L and a guard time gap Gap, wherein K is a non-negative integer.

5. The information transport method according to claim 4, wherein the duration T_ext of the CP extension is determined according to the following formula:
T_ext=L*symbol_length-T_sensing-Gap or T_ext=L*symbol_length-T_sensing,
wherein symbol_length represents a duration of one symbol, and T_sensing represents a duration of listen before talk (LBT).

6. The information transport method according to claim 2, wherein when the indication information indicates that the terminal performs M transports, or indicates M transport resources, M being a positive integer, a resource transported by the terminal over an SL satisfies at least one of the following:
the terminal determines a resource mapping location according to a preset rule or a first parameter;
the terminal determines F interlace resources according to an interlace indication in indication information, wherein F is a positive integer; or
the terminal performs resource mapping in a configured, indicated, or predefined resource mapping manner.

7. The information transport method according to claim 6, wherein
information of the resource mapping location comprises at least one of the following: a start location, an end location, or a resource length; and
the first parameter comprises at least one of the following: source identifier; destination identifier; group identifier; transport type; subcarrier spacing (SCS); quality of service (QOS); or channel access priority class (CAPC).

8. The information transport method according to claim 7, wherein the resource mapping location comprises the start location, and the start location is determined according to the preset rule; and the transporting, by a terminal, information over an SL comprises at least one of the following:
starting mapping, by the terminal in the 1st transport resource, SL information at the 2nd symbol of the transport resource, or information of the 1st symbol is a repetition of information of the 2nd symbol or information of the last half symbol of the 1st symbol is a partial repetition of the information of the 2nd symbol; or
starting mapping, by the terminal in the 2nd to M-th transport resources, SL information at the 1st symbol of the transport resource.

9. The information transport method according to claim 7, wherein the resource mapping location comprises the start location, and the start location is determined according to the first parameter; and the transporting, by a terminal, information over an SL comprises at least one of the following:
when destination identifiers for multiple transports are the same, only in the first transport, information of the 1st symbol is a repetition of information of the 2nd symbol or information of the last half symbol of the 1st symbol is a partial repetition of information of the 2nd symbol;
when destination identifiers for multiple transports are different, in the 1st resource unit in transport resources corresponding to different destination identifiers, information of the 1 st symbol is a repetition of the 2nd symbol or information of the last half symbol of the 1st symbol is a partial repetition of information of the 2nd symbol; or
when an SCS is a first SCS, information of the last half symbol of the 1st symbol is a partial repetition of information of the 2nd symbol.

10. The information transport method according to claim 7, wherein the resource mapping location comprises the end location, and the end location is determined according to the preset rule;
and the transporting, by a terminal, information over an SL comprises at least one of the following:
mapping, by the terminal in first M-1 transport resources, SL information to the last symbol or the N₁-th symbol of the transport resource; or
mapping, by the terminal in the M-th transport resource or the last transport resource, SL information to the penultimate symbol or the (N₁-1)-th symbol of the transport resource, wherein N₁ is a positive integer.

11. The information transport method according to claim 7, wherein the resource mapping location comprises the end location, and the end location is determined according to the first parameter; and the transporting, by a terminal, information over an SL satisfies the following:
when source identifiers for multiple transports are the same, a guard period (GP) is present in the last symbol of the M-th transport resource or in the last transport.

12. The information transport method according to claim 6, wherein the interlace indication satisfies at least one of the following:
the interlace indication indicates the F interlace resources in a bitmap manner;
the interlace indication comprises an index of a start interlace resource;
the interlace indication comprises an index of an end interlace resource; or
the interlace indication comprises a quantity of the interlace resources.

13. The information transport method according to claim 6, wherein the resource mapping manner comprises at least one of the following:
mapping T time domain resources followed by F frequency domain resources;
mapping F frequency domain resources followed by T time domain resources; or
mapping time domain resources first or frequency domain resources first, which is determined based on a first condition,
wherein T or F is a configured, indicated, or predefined positive integer.

14. The information transport method according to claim 1, wherein the performing, by a terminal, SL channel access over an SL comprises: performing, by the terminal, channel monitoring,
wherein a resource location at which the terminal performs channel monitoring satisfies at least one of the following:
the terminal starts monitoring at a start location of a time unit immediately before an indicated resource;
the terminal starts monitoring at a location shifted backward by a time units from a start location of a time unit immediately before an indicated resource;
the terminal starts monitoring at a location shifted forward by b time units from an end location of a time unit immediately before an indicated resource; or
the terminal starts monitoring at a location shifted forward by c time units from a start location of an indicated resource,
wherein a, b, and c are positive integers.

15. A terminal, comprising: a memory storing a computer program; and a processor coupled to the memory and configured to execute the computer program to perform operations comprising:
transporting information over a sidelink (SL) on a shared band,
wherein the transporting information comprises at least one of the following: receiving information, transmitting information, performing channel monitoring, or performing SL channel access.

16. The terminal according to claim 15, wherein the transporting information over an SL comprises: transporting, by the terminal, information over the SL according to indication information, wherein the indication information comprises at least one of the following:
scheduled resource; channel occupancy time (COT) information; remaining COT information; shared resource; resource for monitoring; start location of time domain resource; end location of time domain resource; size or length of time domain resource; start location of frequency domain resource; end location of frequency domain resource; size or length of frequency domain resource; cyclic prefix (CP) extension information; SL channel access type; resource block (RB) set; interlace indication; or remaining interlace indication.

17. The terminal according to claim 16, wherein the indication information is carried in at least one of the following:
first-stage sidelink control information (SCI); second-stage SCI; downlink control information (DCI); media access control control element (MAC CE); or radio resource control (RRC) message.

18. The terminal according to claim 16, wherein the indication information comprises the CP extension information; and before the transporting, by a terminal, information over an SL, the operations further comprise:
determining, by the terminal, information of CP extension according to the CP extension information,
wherein a range indicated by the CP extension information comprises K symbols, or a duration T_ext of the CP extension is determined based on at least one of a configured, indicated, or predefined symbol quantity L and a guard time gap Gap, wherein K is a non-negative integer.

19. The terminal according to claim 18, wherein the duration T_ext of the CP extension is determined according to the following formula:
T_ext=L*symbol_length-T_sensing-Gap or T_ext=L*symbol_length-T_sensing, wherein symbol_length represents a duration of one symbol, and T_sensing represents a duration of listen before talk (LBT).

20. A non-transitory computer-readable storage medium, storing a computer program, when the computer program is executed by a processor, causes the processor to perform operations comprising:
transporting, by a terminal, information over a sidelink (SL) on a shared band,
wherein the transporting information comprises at least one of the following: receiving information, transmitting information, performing channel monitoring, or performing SL channel access.
